(19) United States
(12) Patent Application Publication
(10) Pub. No.: US 2002/0029182 A1
(43) Pub. Date: Mar. 7, 2002

(54) Auction system relating to provision of service, server, auction site, client terminal participating an auction and net auction method, and storage medium therefor

(75) Inventor: Toru Nakagawa, Tokyo-to (JP)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/791,966

(22) Filed: Feb. 23, 2001

(30) Foreign Application Priority Data
Aug. 18, 2000 (JP) 2000-190461

(51) Int. Cl. G06F 17/60

(52) U.S. Cl. 705/37; 705/7

(57) ABSTRACT

### Object

It is one object of the present invention to provide a system using net auctions for making reservations for the provision of personal services by celebrities or by experts possessing superior skills.

### Constitution

A system is provided whereby service time zones for a specific artisan are put up for auction using a scheduling table, and for establishing, at the same time, reservations or schedules. Specifically, an auction system for providing a service comprises: a web server 15 and a CGI server 16, for providing a site for an auction; and a client 11, connected to the servers 15 and 16 via the Internet 10, wherein the servers 15 and the CGI server 16 open, to the public, a scheduling table having a plurality of auction cells, which individually represent predetermined times at which a service can be provided, and for each of which the current state of an auction is displayed, and wherein the client 11 accesses the server 15 or 16 and selects a specific auction cell in the scheduling table based on the current auction state that is displayed, and tenders bids for the service offered by the selected auction cell.

### DETAILED DESCRIPTION OF THE INVENTION

1. Field of the Invention

The present invention relates to an online auction system, and relates in particular to an auction system for personal services that are provided by the unit hour.

2. Background Art

In consonance with the development of network use techniques, such as Internet procedures, online electronic commerce (EC) applications utilizing the Internet have rapidly increased in popularity. One type of EC application, the so-called network auction, provides as a service a site on the Internet for the auctioning off of second-hand cars and personal computers, among other things.

For a net auction, a user who has a product for sale introduces it on his or her Homepage, and users (clients) desiring to purchase the item submit bids by entering a purchase price offer. Then, after the time allocated for the bidding has expired, the user who offered to pay the highest price obtains the product. Since multiple users can simultaneously participate in auctions via the Internet, regardless of the times and locations at which they are held, it is predicted that net auctions will be further developed as an electric commerce application reflecting the characteristics of the Internet.

### PROBLEMS TO BE SOLVED BY THE INVENTION

The offerings available at a conventional net auction are limited to manufactured products, such as cars and personal computers. However, if a net auction could include not only manufactured products but also personal services, to be provided by certain celebrities or by experts possessing superior skills, such as “charismatic” beauticians, master cooks, novel architects, shrewd attorneys, noted doctors and dentists, young entertainers and athletes, a net auction would be very useful both for service providers and consumers, as will be described later.

For example, normally a closed seller's market is established between a charismatic beautician, a service provider, and regular customers, consumers. Therefore, it is difficult for a user who is not a regular customer, but desires to become a consumer, to make a reservation, and even if he or she succeeds in making a reservation, the available reservation time choices will be very limited. Further, at present, the prevailing rule is for most applications for reservations to be submitted by phone, and since whether or not a specific consumer can make a reservation is often contingent on the time a call is placed, such a system is unfair to users. Furthermore, when reservations are made over the phone, the service provider must spare time for establishing times and dates, and scheduling reservations can become a tedious and time consuming task. And finally, should a beautician desire to increase the fee he or she receives for the application of his or her skills, it is difficult to set a reasonable, acceptable price.

To resolve these shortcomings, one object of the present invention is the preparation of a system whereby an auction is used to schedule reservations for the provision of personal services rendered by experts having superior skills, and celebrities.

And further object of the present invention is to enable the consumers to make the reservations taking his or her time and budgets into account as well as the fair chances to get services.

Another object of the present invention is to enable service providers to obtain the highest possible fees, per unit hour, for example, for the exercise of their skills or the provision of their services, and to reduce the labor involved in scheduling reservations.

### SUMMARY OF THE INVENTION

To achieve the above objects, in accordance with the present invention, a system is provided whereby, using a scheduling table, a service time zone for a specific artisan is offered for sale at an auction, while at the same time, reservations are made or schedules are established. Specifically, in accordance with the present invention, an auction system for providing a service comprises: a server for providing a site for an auction; and links, provided via a communication network, for connecting clients to the server, wherein the server opens to the public a scheduling table, which has a plurality of auction cells, that is used to set times during which predetermined services are offered for sale and to display the current state of the auctioning of each of the predetermined services, and wherein one of the clients that has accessed the server selects, based on a current, displayed state, a specific auction cell in the scheduling table and submits bids for the service offered via the selected auction cell.

In accordance with the selection of an auction cell by the client, price bid input screen information is independently generated for each auction cell, and to enter price information, the client uses a price bid input screen that is displayed for the entry of the price bid input screen information.

According to the present invention, a server for providing, via a communication network, a site for an auction comprises: a customer information input screen information generator for generating customer information input screen information used to register customers; a customer information processor for processing the customer information based on entries made by clients on a customer information input screen that is generated in accordance with the customer information input screen information; a scheduling screen information generator for generating scheduling screen information, to include auction cells that are defined for predetermined periods based on scheduling information provided for services; a price bid input screen information generator for generating, based on the selection of specific auction cells by the clients, price bid input screen information that differs for each of the auction cells; and a price bid processor for processing, based on the price information, bids that are entered by the clients on the price bid input screen that is generated in consonance with the price bid input screen information.

Further, according to the present invention, a server comprises: scheduling screen information generation means, relative to the provision of a personal service offered for sale via an auction that is provided, for example, by a specific artisan, for generating scheduling screen information that is divided into predetermined units and for conducting an independent auction for each of the predetermined units; and tender acceptance means for accepting, from a client who visited a site, a tender for a specific unit on a scheduling screen that is generated based on the scheduling screen information. The scheduling screen information generation means generates and displays the scheduling screen information, with which are displayed attributes that include the current price bid for each of the predetermined units, and displays identification information concerning the clients that submitted bids for each of the predetermined units. This configuration is preferable because clients can adjust their schedules and budget and select an optimal cell, and because the clients can confirm the bidding results.

According to the present invention, an auction site for performing a net auction upon the receipt of a request from a service provider comprises: a scheduling screen information generation means, for a plurality of predetermined periods for the provision of services, for generating scheduling screen information for conducting an auction for each of the predetermined periods; tender acceptance means for accepting tenders from clients who visited sites for each of the predetermined periods; and fee establishment means for, at the time the auction is terminated, determining which client shall receive a service and what fee shall be paid.

If the service offered on the net auction is presented as a service that can be provided by a specific artisan during a predetermined period, a client can be easily and fairly obtain a reservation for a service that is available on an absolute sellers' market.

Furthermore, according to the present invention, a client terminal used to visit a web site via the Internet and participate in an auction comprises: display means for receiving, from a web site, a scheduling table, which is divided into predetermined periods in accordance with the provision of a specific service, and in accordance with which an auction is independently performed for a set period, and for displaying the scheduling table; and selection means for selecting, from the scheduling table that is displayed on the display means, a period during which the client terminal shall participate in an auction.

The display means includes input means for displaying a price bid input screen for the selected period, and for entering price information based on the price bid input screen that is displayed.

Further, to achieve the above objects, according to the present invention, a net auction method is provided for performing, via a communication network, an auction to provide a service whereby a service provider opens to the public, on a site, a scheduling table which includes auction cells that are prepared for predetermined periods at which a service is to be provided, and in which a state for the tendering of an offer is displayed for each of the auction cells; and whereby a client who has visited the site selects from the scheduling table a predetermined auction cell, and tenders an offer for the selected action cell.

According to the present invention, a net auction method comprises the steps of: generating scheduling screen information, concerning the provision of a service at an auction, that is divided into days and/or times in accordance with predetermined periods that are independently established for the auction, so that an independent auction can be performed for each of the-predetermined periods; and accepting an offer that is tendered by a client for the predetermined period listed on a scheduling screen, which is displayed on the client side, based on the scheduling screen information.

According to the present invention, a storage medium is provided on which input means for a computer stores a computer-readable program, which permits the computer to perform: a process for generating customer information input screen information for the input of customer information; a process for processing the customer information that is input using a customer information input screen that is displayed based on the customer information input screen information; a process for generating scheduling screen information that is divided into predetermined periods for the provision of the service at an auction, and for independently auctioning each of the predetermined periods; and a process for accepting offers independently tendered by clients for each of the predetermined periods included on a scheduling screen displayed using the scheduling screen information. In this instance, the storage medium that is used can include a CD-ROM and a hard disk drive.

### PREFERRED EMBODIMENT

The present invention will now be described in detail during the course of the explanation of the preferred embodiment, which is given while referring to the accompanying drawings.

FIG. 1 is a diagram for explaining the general configuration of a system according to this embodiment. The Internet 10 is a network environment for conducting an auction, and a client (a consumer, a customer or a user) 11 is an entity the tenders an offer for the auction of a service. In the embodiment, the process whereby the client 11 participates in an auction is explained by using the term “tender” or “bid.” The client 11 includes a browser 12 for scanning an HTML (HyperText Markup Language) file. To specify a user, a cookie can be used by the client 11 to transmit an access ID to a web server 15.

The web server 15 provides a predetermined file or data for the client 11 via the Internet 10. A CGI (Common Gateway Interface) server calls up a predetermined program upon the receipt of a request from the browser 12 in the client 11, and returns the results obtained by the execution of the program to the browser 12. The CGI server 16 includes a plurality of CGIs, and performs an application for permitting the browser 12 to enter data having various forms and for returning the results thereto. Physically, the CGI server 16 can also be integrally formed with the web server 15. In this embodiment, the web server 15 and the CGI server 16 serve as providers for holding an auction for the provision of a skill or a service. In the client 11, the browser 12 is mounted in a personal computer (PC), which includes a display device provided with a screen, and a keyboard and a pointing device for the entry of various data. The web server 15 and the CGI server 16 include a memory for storing a program that executes the processing for this embodiment, and also include a function for reading such a program from an external memory device, such as a CD-ROM.

FIG. 2 is a diagram showing a system configuration according to this embodiment. The CGI server 16 includes interfaces CGI1 to CGI15, and also stores schedule information 31, tender information 32 and customer information 33. The interface CGI1 functions as an ID search unit 21 for, in response to a URL access by the browser 12, searching for an ID based on the received access ID and the customer information 33, and as a scheduling screen information generator 22, for generating scheduling screen information based on the scheduling information 31 and the tender information 32. The interface CGI1 transmits the obtained scheduling screen information to the browser 12, and the interface CGI2 functions as a price bid input screen information generator 23 for, in response to the clicking of the browser 12 to select an auction cell, generating price bid input screen information. The interface CGI2 transmits the obtained price bid input screen information to the browser 12, and the price bid input screen information generator 23 transmits the obtained price bid input screen information to the browser 12. When the price bid input screen generator 23 ascertains a customer is not registered, by referring to the customer information 33, the generator 23 does not generate and transmit the price bid input screen information.

The interface CGI3 serves as a price bid processor 24 for processing the price bid received from the browser 12. The price bid information obtained by the price bid processor 24 is reflected in the schedule information 31 and the tender information 32. The interface CGI4 serves as a customer information input screen information generator 25, for responding to the clicking of a customer registration button using the browser 12, and for generating customer information input screen information that is transmitted to the browser 12. The interface CGI5 serves as a customer information processor 26 and as a customer ID generator 27; the customer information processor 26 processing the customer information, such as the name, address and telephone number of a customer, received from the browser 12, and the customer ID generator 27 generating a customer ID and including it in the customer information 33.

FIG. 3 is a conceptual data diagram for the scheduling information 31, the tender information 32, and the customer information 33. The scheduling information 31 is divided in accordance, for example, with the days and the times of a week and has the shape of a matrix. Cells (auction cells), each of which is constituted by a matrix, have independent states, which can be displayed. Therefore, included for each auction cell is information, such as the status, the tender period, the lowest price bid, and a pointer (PTR) In this embodiment, an auction can be held for each independent auction cell, and the time unit for defining an auction cell, which can be arbitrarily determined and may, for instance, be a unit of half an hour, an hour, half a day or a day, differs depending on the service to be provided.

FIG. 4 is a diagram for explaining the status of each auction cell. Included in the scheduling information 31 are two statuses for each auction cell: an invalid status, indicating that an auction is not being held, and a valid status, indicating an auction is being held. An invalid status indicates, for example, a regular day off, an auction that has not yet been opened for bids, or an auction that has been terminated (closed). A valid status indicates, for example, an auction that has been opened but for which no tender has yet been received or one for which tenders are being received. When a scheduling table is provided for the client 11, these statuses can be displayed, with an invalid status, for example, being indicated by a “closed” mark.

For the scheduling information 31 in FIG. 3, the tender period can also be determined for each auction cell. In addition, a lowest price bid can be set for each auction cell, and a higher lowest price bid can be set for an auction cell that corresponds to the days of the week or to the time periods that are the most convenient for customers. The scheduling information 31 is so designed that an offer that is tendered outside the tendering period or that is less than the lowest price bid will not be accepted. Further, a pointer is provided for the scheduling information 31 that points at the latest tender information for each auction cell.

In the tender information 32, the customer ID, the price bid, the tender date and the pointer are stored for each auction cell based on a price entered by the browser 12. The pointer points to the latest customer information, and the tender information 32 includes tender information for all the customers who tendered offers in the past. The customer information 33 includes the customer ID obtained from the tender information 32 and access ID received by using a cookie. Furthermore, for each customer the name, the address and the telephone number are stored as personal information.

FIG. 5 is a diagram showing an example scheduling table display. The scheduling table is prepared by using the scheduling screen information generator 22 of the CGI server 16, and is displayed on the screen of the browser 12 of the client 11. A site visitor (a client 11) selects a service provider who is featured at the site, for example, a charismatic beautician A, for whom, in this example, a scheduling table is employed. According to the scheduling table in FIG. 5, a plurality of independent auction cells 51, having a matrix shape, are prepared by dividing the time into days and hours. Then, when the client 11 selects an auction cell 51 for an auction in which he or she desires to participate, a link with the price bid input screen, which will be described later, is successfully effected, and the following tendering process can be performed, while simultaneously the status represented by the entry “end” is displayed for each of the other auction cells 51. The auction cell 51 wherein the auction is currently held has, as its attributes, a current auction price, which is information required for the auction, and an access ID for identifying a tenderer, and these attributes are displayed so that they can be understood at a glance. A registration button 52 and an end button 53 are also displayed on the screen of the scheduling table, and when the client 11 clicks on the registration button 52, the operating mode is shifted to the customer registration mode, while when the client 11 clicks on the end button 53, the operating mode is shifted to the end mode and the auction operation is terminated.

FIGS. 6A and 6B are diagrams showing an example customer information input screen and a price bid input screen. When the registration button 52 in FIG. 5 is selected or the selected auction cell 51 has not yet been registered, the customer information input screen information is generated by the customer information input screen information generator 25 of the CGI server 16. Then, the customer information input screen shown in FIG. 6A is displayed by the browser 12 of the client 11. In this example, customer information, such as the name, the address and the telephone number of a customer, can be input using the screen, and when a registration button 61 is clicked on by the client 11, the information that has been entered is processed by the customer information processor 26 of the CGI server 16. Thereafter, when a cancel button 62 is clicked on, the entered customer information is canceled.

When one of the auction cells 51 in FIG. 5 is selected by the browser 12, the price bid input screen information is generated by the price bid input screen information generator 23 of the CGI server 16, and is displayed by the browser 12. In the example in FIG. 6B, the name and the ID obtained from the customer information 33, the tender date determined by the selected auction cell 51, and the current price bid for the selected auction cell 51 are displayed. When the client 11 enters a price bid and clicks on a tender button 63, the price bid is processed by the price bid processor 24 of the CGI server 16. Thereafter, when the client 11 clicks on a cancel button 64, the price bid is canceled.

FIG. 7 is a flowchart showing the operation performed for this embodiment. First, the client 11, a site visitor (customer), visits a web site, selects a desired service provider and requests the display of the scheduling table in FIG. 5 (step 101). The client 11 then selects (clicks on) a specific auction cell 51, and the registration button 52 or the end button 53 in the obtained scheduling table (step 102). When the client 11 tenders the first offer, the registration button 52 is used to enter the information required for identifying the client 11. Then, when the registration button 52 is selected, the customer information input screen (customer registration screen) information is generated by the customer information input screen generator 25 of the CGI server 16, and is displayed by the browser 12 (step 103). Subsequently, the customer information is entered by the client 11, and is processed by the customer information processor 26, etc. (step 104).

When, at step 102, a specific auction cell 51 is selected (clicked on), a check is performed to determine whether an auction participant has been registered or not (step 105). If the participant has not yet been registered, program control shifts to step 103 to display the customer registration screen. If the participant has been registered, the price bid input screen information is generated by the price bid input screen information generator 23 of the CGI server 16, and based on this information, the price bid input screen is displayed by the browser 12 (step 106). Thereafter, the price bid is entered by the client 11, and is processed by the price bid processor 24 of the CGI server 16 (step 107).

However, when the end button 53 is selected at step 102, the tender operation is terminated.

FIGS. 8A and 8B are detailed flowcharts showing the processing performed at step 104 in FIG. 7 to register the customer information. The processing in FIG. 8A is performed by the client 11, and the processing in FIG. 8B is performed by the server (the web server 15 and the CGI server 16). As is shown in FIG. 8A, the client 11 uses the customer information input screen in FIG. 6A to enter the customer information (step 111). Then, a check is performed to determine whether the registration button 61 or the cancel button 62 has been selected (step 112). When the cancel button 62 has been selected, the customer information registration processing is terminated. But when the registration button 61 has been selected, the parameter including the customer information is sent to the server.

In the CGI server 16 that received the customer information, the customer ID generator 27 generates and issues a customer ID (step 113). Then, the customer information processor 26 processes the personal information, such as the customer ID and the name, the address and the telephone number of the customer, and stores it as the customer information 33 (step 114). Thereafter, the customer information registration processing is terminated.

FIGS. 9A and 9B are detailed flowcharts showing the tendering processing performed at step 107 in FIG. 7. The processing in FIG. 9A is performed by the client 11, and the processing in FIG. 9B is performed by the server (the web server 15 and the CGI server 16). In FIG. 9A, the price bid input screen in FIG. 6B is displayed by the browser 12 of the client 11, and the price bid is entered for a specific auction cell 51 (step 121). Then, the tender button 63 or the cancel button 64 is selected (step 122). When the cancel button 64 is selected, program control is returned to the process for displaying the scheduling table. But when the tender button 63 is selected, the information for the price bid is transmitted to the server.

Upon the receipt of the price bid information, the price bid processor 24 of the CGI server 16 determines whether the status indicates no offer has been tendered, as is shown in FIG. 9B (step 123). When the status indicates no office has been tendered, a check is performed to determine whether the price bid entered by the client 11 is equal to or higher than the lowest price bid (step 124). If the value entered by the client 11 is lower than the lowest price bid, the price bid input screen is displayed again (step 125), and the tender processing is terminated. If the value entered by the client 11 is equal to or higher than the lowest price bid, the tender information area is generated for the dynamical changing of the tender information (step 126). When, at step 123, an offer was previously tendered, a check is performed to determine whether the price bid entered by the client 11 is higher than the latest price bid (current price bid) (step 130). If the value entered by the client 11 is lower than the current price bid, the new offer tendered is not accepted, and the price bid input screen is displayed again (step 125). When the new price bid is greater than the current price bid, it is assumed as a new tender and the tender information area is generated (step 126).

When the tender information area is generated at step 126, the pointer is changed to point at the latest tender (step 127). This pointer is effective to maintain the input history, and the previous tender can be pointed by changing the pointer. The data are written to the tender information 32, such as the customer ID, the price bid and the bidding date (step 128), and the status is updated (step 129). The tendering processing is thereafter terminated. The status is updated in order to sequentially update and display the tender information 32, which is necessary to display information concerning the customer who has participated in the auction cell 51 and his or her price bid. In this embodiment, the tendering can be performed for each auction cell 51, and the price bid can be accepted and processed for each auction cell 51. Further, since the processing differs depending on whether the price bid is higher than the lowest price bid and on whether the price bid is higher than the previous price bid, an auction can be performed smoothly. In addition, since the tender information 32 can be dynamically prepared by generating the tender information area, and since the past tender status is stored as history, these data can be used to determine the lowest price to be used when the next schedule is provided. During the tender processing, the customer, the charge and the reservation are determined when the auction is ended following the expiration of the tender period that is defined in advance (e.g., one month preceding the day and time of the reservation).

FIG. 10 is a diagram for explaining the general configuration of a business model for which the embodiment is applied. The business model is constituted by three persons, an artisan 71, such as a charismatic beautician who provides a service; an auction site manager 72, who runs an auction site; and a customer 73, who participates in an auction. The artisan 71 and the intermediator 72 can be the same body. The auction site manager 72 can obtain either or both of the participant fee for the customer 73 and the commission fee for the artisan 71, and can manage the auction site.

As is shown in FIG. 10, first, the artisan 71 submits a request to the auction site manager 72 to hold an auction (\mathring{1}), and then the customer 73 submits an application to participate in the auction to the auction site manager 72 and the auction is held (\mathring{2}). Following this, the auction site manager 72 uses the telephone or an e-mail to transmit to the customer 73 notification and confirmation that the tender was accepted (\mathring{3}), while at the same time transmitting notification of the auction results to the artisan 71 (\mathring{4}) As this notification, the determined scheduling table is transmitted to the artisan 71 via the Internet. Subsequently, the artisan 71 provides a service for the customer 72 (\mathring{5}) and the customer 72 remits payment to the artisan 71 for the charge (\mathring{6}). In this manner, the business model using the embodiment can be established.

As is described above in detail in accordance with the present invention, for a specific period of time, the service or skill provider opens to the public a scheduling table on the web for the time his or her service is available. This scheduling table represents the current status for each day and hour, e.g., auction completed, reserved times, auction in progress and current price bid. In order to participate in an auction, a customer who desires the service visits the web site, examines the scheduling table of the target service provider and selects an auction cell for an auction in progress for a convenient date. Therefore, even though a seller's market may exist between a service provider and a customer, the customer can make a reservation fairly easily, while simultaneously adjusting the time and taking his or her budget into consideration. Furthermore, the service provider can avoid having to perform a troublesome process, using a telephone to accept a client call and to schedule a reservation; and since the reservation is scheduled automatically, the labor required of the service provider can be considerably reduced. Finally, the service provider can obtain a higher fee for the service he or she provides the customer.

In this embodiment, a scheduling table is used for services that are provided by the hour; however, a scheduling table may be prepared that represents days or weeks. For example, when a professional baseball player agrees to coach amateur teams, an auction form representing days is preferable, and in this case, a scheduling table that provides for auctions to be held for full days should be prepared. Further, although in this embodiment a service is provided by a person, the embodiment can be applied for other facilities for which holding auctions using scheduling tables is appropriate, such as making reservations for a wedding hall, for a meeting room in a famous hotel in Tokyo, or for a concert hall.

### ADVANTAGES OF THE INVENTION

As is described above, in accordance with the present invention, a system is provided according to which auctions are held to schedule reservations for the provision of personal services by celebrities or by experts possessing superior skills.

### BRIEF DESCRIPTION OF THE DRAWINGS

FIG. 1 is a diagram for explaining the general configuration of a system according to the preferred embodiment of the present invention.

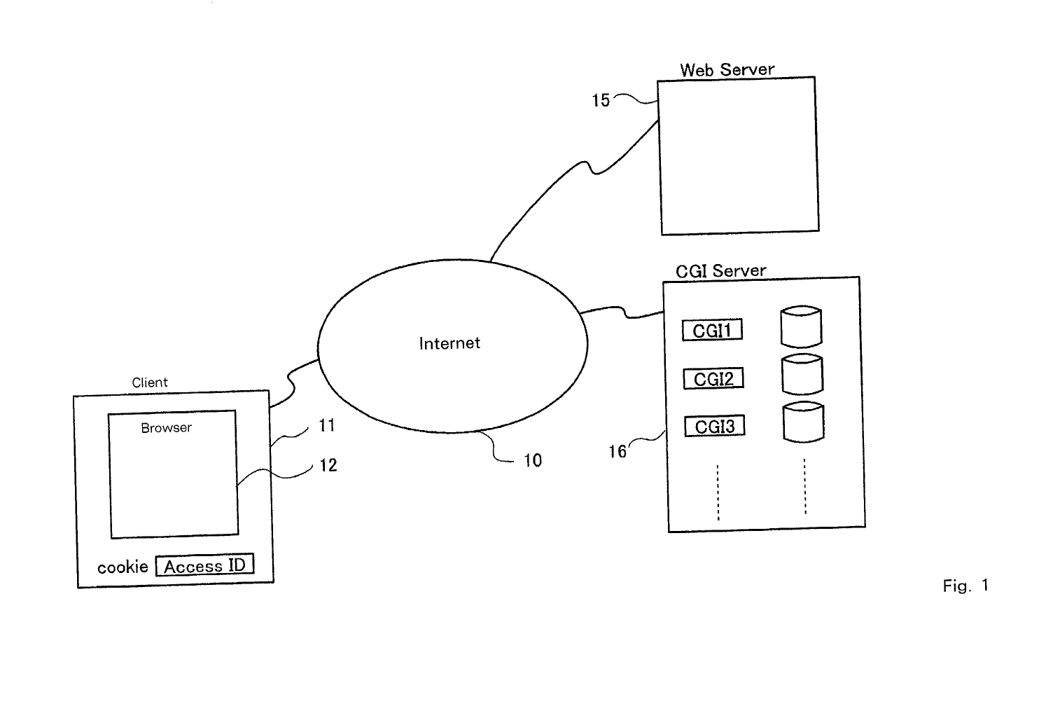

FIG. 2 is a diagram illustrating a system configuration according to the embodiment.

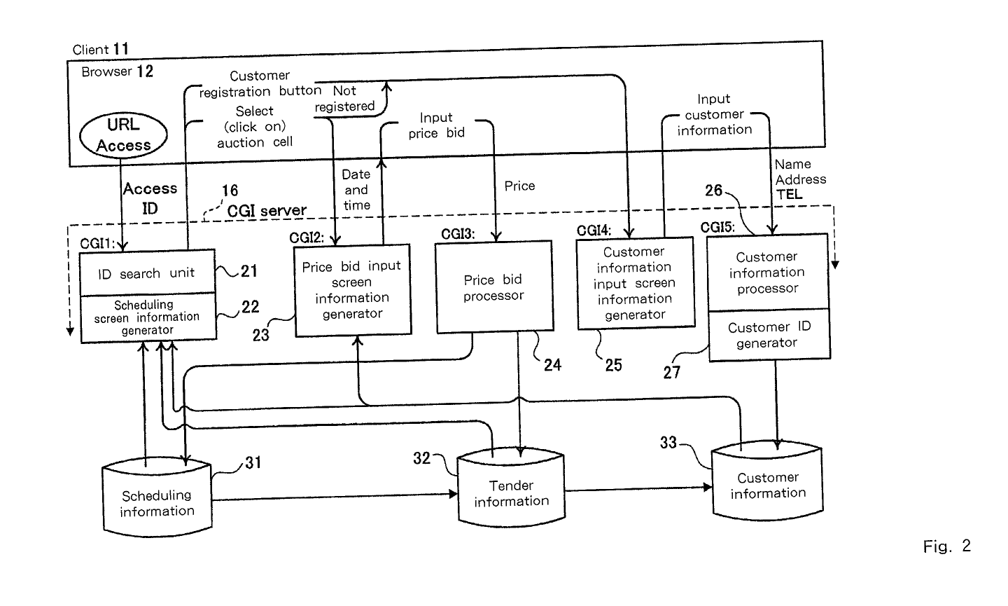

FIG. 3 is a conceptual data diagram showing schedule information 31, tender information 32 and customer information 33.

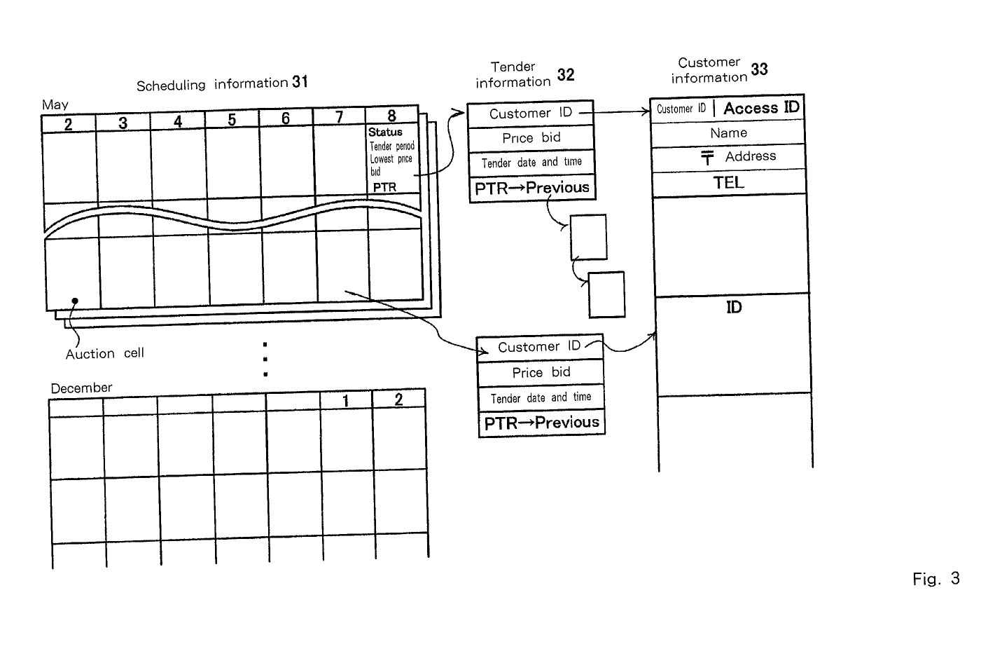

FIG. 4 is a diagram for explaining the status of each auction cell.

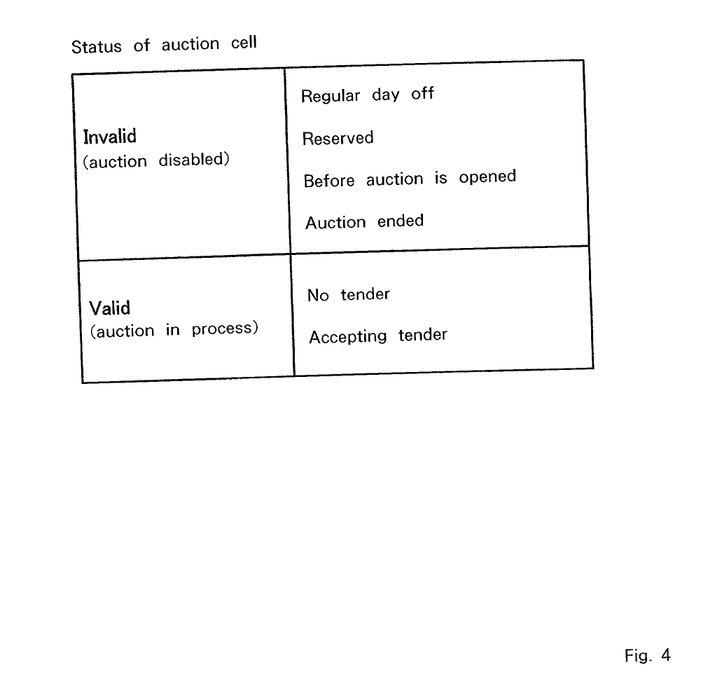

FIG. 5 is a diagram showing an example display for a scheduling table.

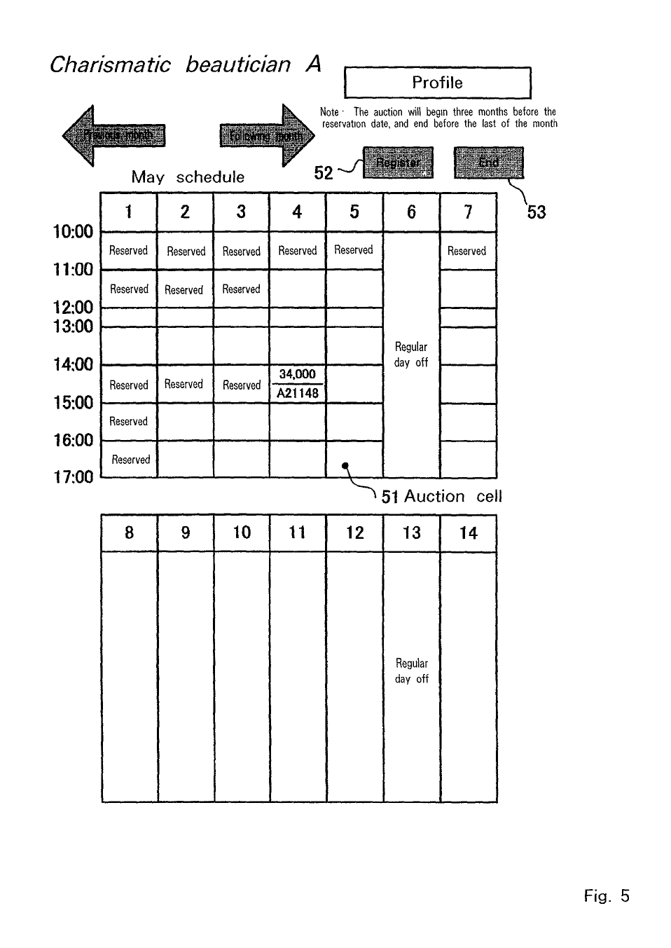

FIGS. 6A and 6B are diagrams showing examples for a customer information input screen and a price bid input screen.

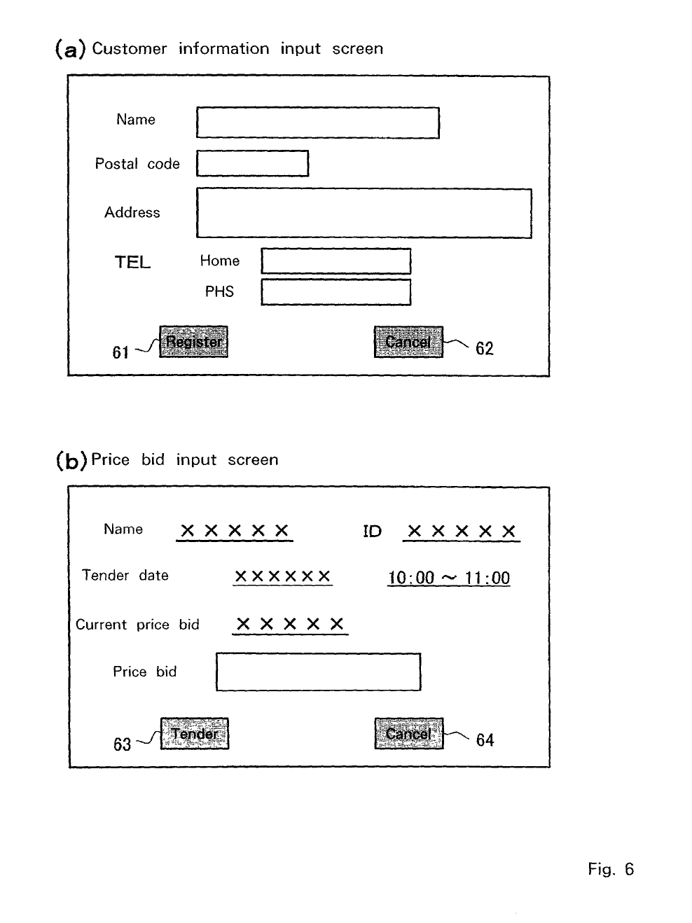

FIG. 7 is a flowchart showing the operation performed in accordance with the embodiment.

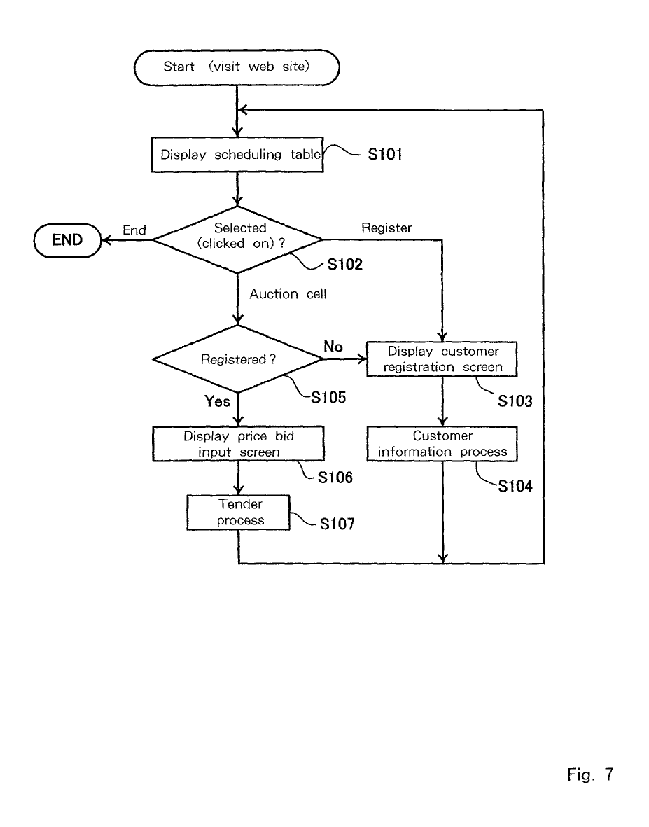

FIGS. 8A and 8B are flowcharts showing the processing performed for customer information registration.

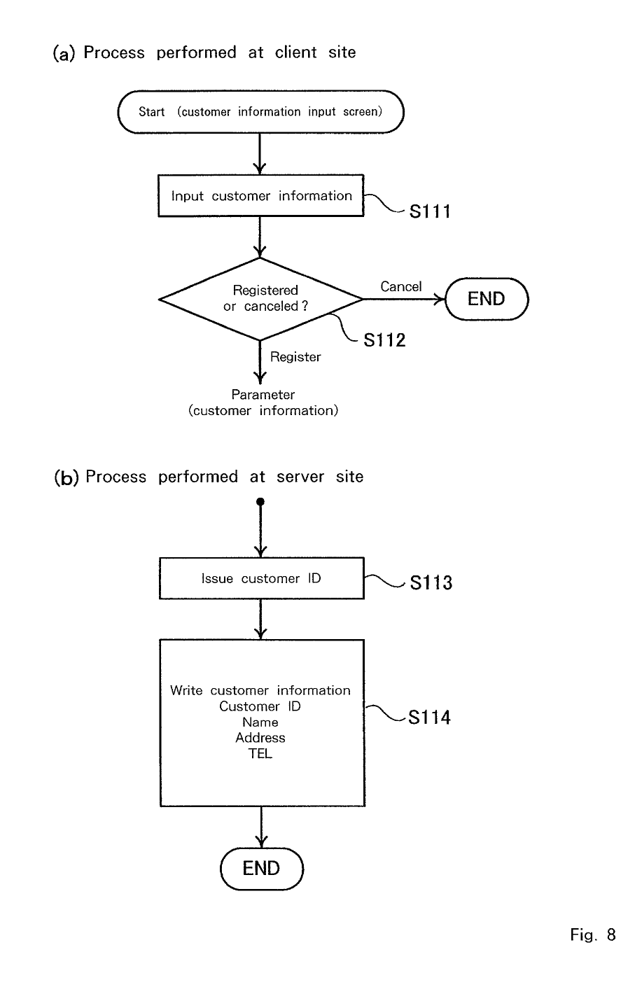

FIGS. 9A and 9B are flowcharts the processing performed for tendering offers.

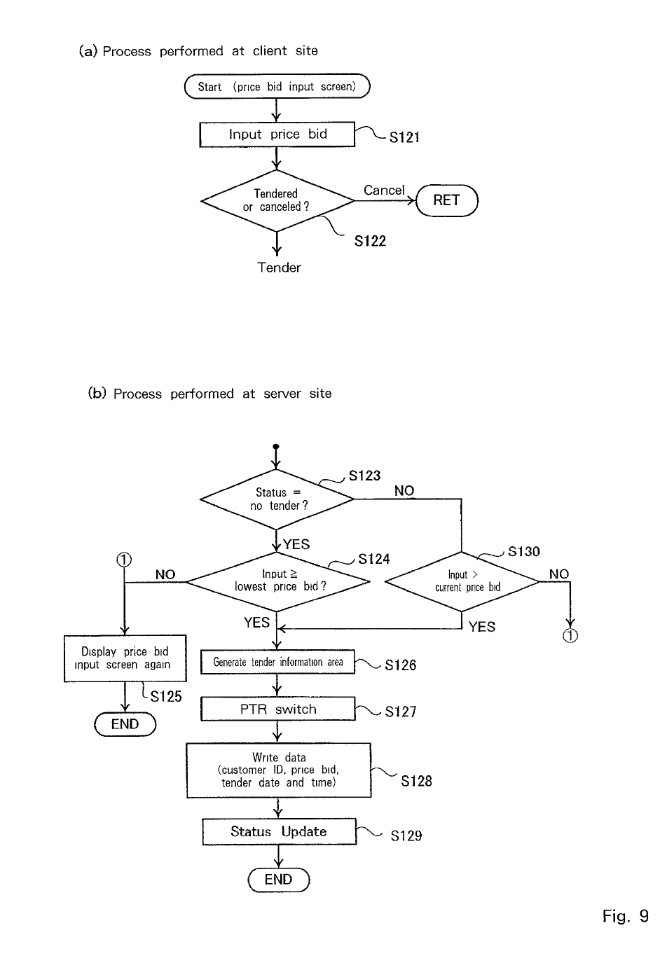

FIG. 10 is a diagram for explaining the general configuration of a business model to which the embodiment is applied.

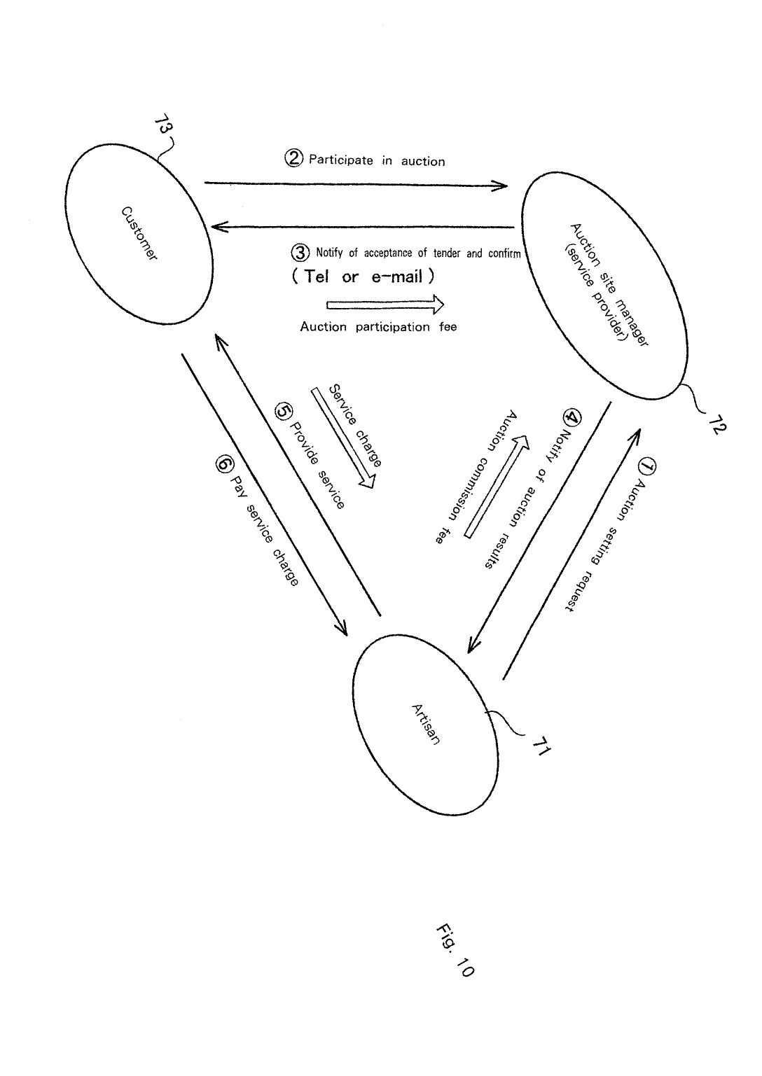

### DESCRIPTION OF THE SYMBOLS

10: Internet

11: Client (consumer, customer, user)

15: Web server

16: CGI server

21: ID search unit

22: Scheduling screen information generator

23: Price bid input screen information generator

24: Price bid processor

25: Customer information input screen information generator

26: Customer information processor

27: Customer ID generator

31: Schedule information

32: Tender information

33: Customer information

51: Auction cell

52: Registration button

53: End button

61: Registration button

62: Cancel button

63: Tender button

64: Cancel button

71: Artisan

72: Auction site manager

73: Customer

1. An auction system for providing a service comprising:
a server for providing a site for an auction; and
a client connected to the server via a communication network,
wherein the server opens to the public a scheduling table, which has a plurality of auction cells, that is used to set times during which predetermined services are offered for sale and to display the current state of the auctioning of each of the predetermined services, and
wherein the client that has accessed the server selects the state, a specific auction cell in the scheduling table and submits bids for the selected auction cell.

2. The auction system according to claim 1, wherein, in the scheduling table opened to the public by the server, the current status of an auction is displayed for each of the auction cells, and wherein the client selects a specific auction cell based on the current status that is displayed.

3. The auction system according to claim 1, wherein, in accordance with the selection of an auction cell by the client, price bit input screen information is independently generated for each auction cell; and wherein to enter price information, the client uses a price bid input screen that is displayed for the entry of the price bid input screen information.

4. A server for providing, via a communication network, a site for an auction comprising:
a scheduling image information generator for generating scheduling screen information having auction cells that are divided according to predetermined periods based on scheduling information provided for services;
a bid price processor for processing bid prices based on the price information that are entered by the clients so as to correspond to a certain auction cell on the scheduling screen that is generated according to the scheduling screen information.

5. The server according to claim 4, further comprising:
a customer information input screen information generator, for generating customer information input screen information for registering a customer; and
a customer information processor, for processing customer information based on data that the client has entered using the customer information screen generated by the customer information input screen information.

6. The server according to claim 4, wherein the price bid input screen information generator generates price bid input screen information that differs for each auction cell.

7. A server for providing, via a communication network, a site for an auction, comprising:
scheduling screen information generation means for generating scheduling screen information that is divided into predetermined units and for conducting an independent auction for each of the predetermined units; and
tender acceptance means for accepting, from a client who visited a site, a tender for a specific unit on a scheduling screen that is generated based on the scheduling screen information.

8. The server according to claim 7, wherein the service offered for the auction is a personal service provided by an artisan.

9. The server according to claim 7, wherein the scheduling screen information generation means generates, for each of the predetermined units, the scheduling screen information that displays corresponding attributes.

10. The server according to claim 9, wherein the attributes displayed on the scheduling screen includes a current auction price for each of the predetermined units and identification information concerning a client who has tendered the current auction price.

11. An auction site for performing an auction upon the receipt of a request from a service provider comprising:
a scheduling screen information generation means for generating, for each of multiple unit periods during which a service for an auction requested by the service provider is provided, scheduling screen information for conducting an auction for each predetermined period;
tender acceptance means for accepting tenders from clients who visited sites for the predetermined period; and
fee establishment means for determining, at the end of the auction and for each predetermined period, which client can receive the service and what fee shall be paid.

12. The auction site according to claim 11, wherein the service offered by the net auction is a service that can be provided by an artisan for each of the predetermined unit periods.

13. A client terminal used to visit a web site via the Internet and participate in an auction comprising:
display means for receiving, from a web site, a scheduling table, which is divided into predetermined periods in accordance with the provision of a specific service, and in accordance with which an auction is independently performed for a set period, and for displaying the scheduling table; and
selection means for selecting, from the scheduling table that is displayed on the display means, a period during which the client terminal shall participate in an auction.

14. The client terminal according to claim 13, wherein the display means displays a price bid input screen for the period selected by the selection means, and wherein input means is included for the input of money value information using the price bid input screen.

15. A net auction method, via a communication network, providing an auction regarding to provide a service, comprising the steps of: a service provider publishes to the public, on a site, a scheduling table which includes auction cells that are prepared for predetermined periods at which a service is to be provided; and a client who has visited the site selects from the scheduling table a certain auction cell, and tenders an offer for the selected action cell.

16. The net auction method according to claim 15, wherein offer tender status is displayed for each of the auction cells in the scheduling table that is opened to the public.

17. A net auction method for holding an auction, via a communication network, for providing a service, comprises the steps of:
generating scheduling screen information, concerning the provision of a service at an auction, that is divided into days and/or times in accordance with predetermined periods that are independently established for the auction, so that an independent auction can be performed for each of the predetermined periods; and
accepting an offer that is tendered by a client for the predetermined period listed on a scheduling screen, which is displayed on the client side, based on the scheduling screen information.

18. The net auction method according to claim 17, wherein the predetermined unit periods represent days and/or hours, and are independently used as targets for an auction.

19. A storage medium is provided on which input means for a computer stores a computer-readable program, which permits the computer to perform:
a process for generating scheduling screen information that is divided into predetermined periods for the provision of the service at an auction, and for independently auctioning each of the predetermined periods; and
a process for accepting offers independently tendered by clients for each of the predetermined periods included on a scheduling screen displayed using the scheduling screen information.

20. The storage medium according to claim 19, wherein the computer-readable program further permits the computer to perform:
a process for generating customer information input screen for the input of customer information; and
a process for processing the customer information that is input using a customer information input screen that is displayed based on the customer information input screen information.
